(19) United States
(12) Patent Application Publication
(10) Pub. No.: US 2004/0263324 A1
(43) Pub. Date: Dec. 30, 2004

(54) Tire pressure sensor body and installation method

(76) Inventors: Ramon A. Sanchez, Juarez (MX); Manuel S. Sanchez, Juarez (MX)

Correspondence Address: DELPHI TECHNOLOGIES, INC., M/C 480-410-202, PO BOX 5052, TROY, MI, 48007, US

(21) Appl. No.: 10/602,843

(22) Filed: Jun. 24, 2003

(51) Int. Cl. B60C 23/00

(52) U.S. Cl. 340/442

(57) ABSTRACT

A tire pressure sensor unit having a sensor body including a housing and an integral nipple which is upstanding in perpendicular relation to a mounting surface of the housing. The housing has a cavity in which is located a tire air pressure sensor, wherein the nipple has a passage therethrough which communicates with the cavity. The cavity is entirely air tight except for the passage of the nipple. The nipple includes an annular flange at its distal end, forming thereby a reduced cross-section portion between the annular flange and the mounting surface of the housing. The nipple passes sealing through a port hole provided in a wheel rim, and an adhesive is applied to the mounting surface to secure the housing to the hub-side of the wheel rim.

### TECHNICAL FIELD

The present invention relates to pneumatic tires, and more particularly to air pressure sensor units therefor. Still more particularly, the present invention relates to a sensor body which packages a pneumatic tire air pressure sensor for universal mounting to wheel rims.

### BACKGROUND OF THE INVENTION

Maintaining proper tire inflation is an important part of automotive vehicle ownership. Proper pneumatic tire inflation, in which a predetermined air pressure within the tire is provided, results in optimum tire performance, and this translates into a number of additional benefits, including, longer tire life, better ride, and improved steering control and stopping distance. Even through the maintenance of tire pressure is important, the owner has been expected to check tire pressure by doing periodic visual inspection, and actual tire stem pressure gauging, of the tires.

One of the recent advances in automotive technology has been the introduction of tire pressure monitoring systems. A pnuematic tire air pressure (tire pressure) sensor unit is an important component of an automotive tire pressure monitoring system. An active tire pressure sensor unit includes pressure sensor components for wireless transmission of tire pressure data (and, optionally, other data, as for example temperature and acceleration) to the tire pressure monitoring system, as well as packaging therefor. An active tire pressure sensor includes an air pressure sensing element, a power source, an electronic circuit board and a transmitter, all of which being packaged in a sensor body.

Usually, the sensor body is joined to the valve stem. This attachment modality provides a low cost attachment of the sensor body to the wheel rim. However, a custom made valve stem and nut design has to be used for every kind of wheel rim (passenger vehicles, tractor-trailers, etc). This presents a problem, in that there is no universal sensor body.

Another attachment modality for attaching a sensor body to a wheel rim is via a fastening belt, but this modality requires different lengths of belts for different wheels. This situation generates a diversification in models, parts and manufacturing processes that increase the over-all cost of the tire pressure sensor.

In order to obtain a “universal mount” tire pressure sensor, special valve stems are fabricated which pass through a bracket in order to adapt to the angle of the wheel rim. In other cases, a hollow screw is overmolded by the sensor body and then is attached to a custom made, snap-in tire valve as if it were a nut. However, these “universal mount” configurations require components (valves, belts, etc.) that are additional to the tire pressure sensor. These extra components represent a considerable cost as compared to the tire pressure sensor, itself, and further require additional manufacturing operations in order to install them to the wheel rim.

Accordingly, what remains needed in the art is a tire pressure sensor unit which has universal mount functionality without necessity of extra components and is mounted to the hub-side of the wheel rim, as opposed to the tire-side of the wheel rim which is the custom of the prior art.

### SUMMARY OF THE INVENTION

The present invention is a tire pressure sensor unit including a sensor body configured for being universally mountable to the hub-side of a wheel rim without necessity of extra components.

The sensor body according to the present invention includes a housing and a nipple sealing connected therewith. The nipple projects, in an upstanding, perpendicular relation, from a mounting surface of the housing. The housing has a cavity in which is located a tire air pressure sensor, wherein the nipple has a passage therethrough which communicates with the cavity. In this regard, the cavity is entirely air tight except for the passage of the nipple. The nipple includes an annular flange at its distal end, forming thereby a reduced cross-section portion between the annular flange and the mounting surface of the housing.

In operation, a port hole is provided at a selected location of a wheel rim. An adhesive is applied to the mounting surface. Thereupon, the nipple is pushed through the port hole such that the annular flange abuts, in circumscribing relation to the port hole, the wheel rim at the tire-side thereof, and further such that the mounting surface is closely adjacent the hub-side of the wheel rim, spaced by a layer of the adhesive which contacts both the wheel rim and the mounting surface. Upon curing of the adhesive, the tire is then inflated to a recommended air pressure. The air pressure within the tire communicates with the pressure sensor in the cavity via the passage. Once the tire is inflated, the tire pressure does not diminish over time because of the sealing provided by the nipple and the adhesive which independently and in combination yield an air tight seal of the sensor body with respect to the wheel rim at the port hole thereof.

Accordingly, it is an object of the present invention to provide a tire pressure sensor unit which has a universally mountable sensor body for placement at the hub-side of the wheel rim, wherein extra components are obviated.

This and additional objects, features and advantages of the present invention will become clearer from the following specification of a preferred embodiment.

### BRIEF DESCRIPTION OF THE DRAWINGS

FIG. 1 is a side elevational view of a sensor body according to the present invention.

FIG. 2 is a top elevational view, seen along line 2-2 of FIG. 1.

FIG. 3 is a partly cut-away, side view of the sensor body of FIG. 1, showing certain of the sensor components therewithin.

FIG. 4 is a side view of the sensor body of FIG. 1, shown in operation with respect to a wheel rim shown in cross-section.

FIG. 5 is a perspective view of the hub-side of a wheel rim having the sensor body of FIG. 1 installed thereon.

FIG. 6 is a perspective view of the tire-side of the wheel rim of FIG. 5 having the sensor body of FIG. 1 installed thereon.

### DESCRIPTION OF THE PREFERRED EMBODIMENT

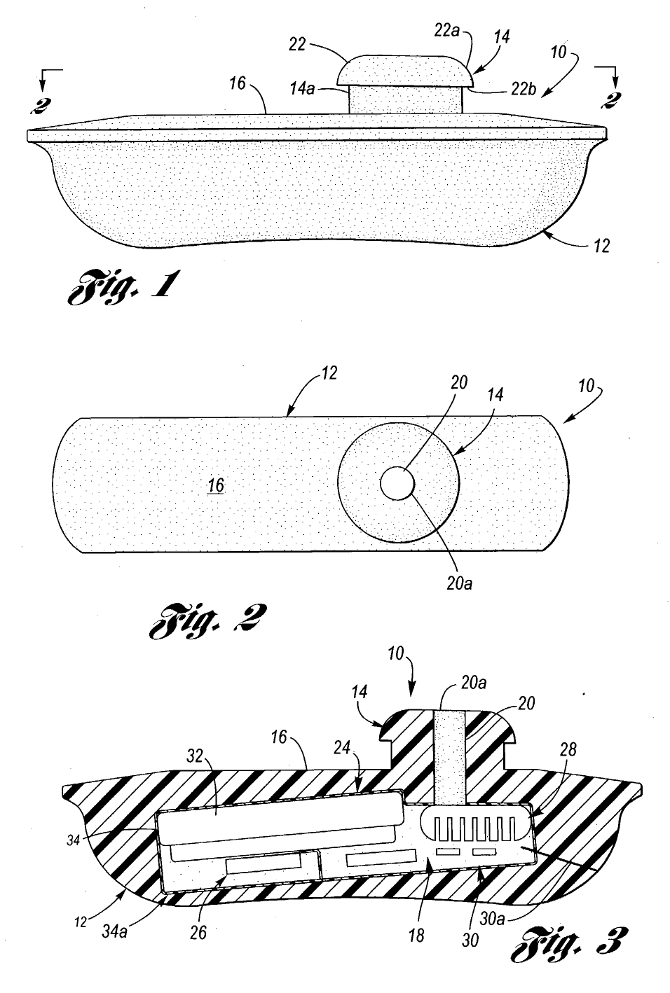

Referring now to the Drawing, FIGS. 1 through 3 depict a preferred embodiment of a tire pressure sensor unit 100 including a sensor body 10 according to the present invention. The sensor body 10 includes a housing 12 and an integral nipple 14. The housing 12 has a mounting surface 16 which is elongated and convexly curved along the elongation, wherein the convex curvature has a radius that is consonant generally with the concave curvature of a range of hub-side curvatures of wheel rims. The nipple 14 is located at the mounting surface 16 and is oriented in perpendicular, upstanding relation thereto. A preferred sensor body 10 is composed of, for example, natural rubber, neoprene, low pressure resin, a plastic framework overmolded by an elastomeric material, or other suitable materials which are durable and pressure resistant.

The housing 12 provides a cavity 18 (see FIG. 3), and the nipple 14 has a passage 20 passing entirely therethrough, which communicates with the cavity. The sensor body 10 provides air tight integrity of the cavity 18 and the nipple 14 such that the cavity can only communicate with air pressure of the external environment via the passage 20.

The nipple 14 has an annular flange 22 at its distal end whereat is located an orifice 20a of the passage 20. The annular flange is characterized by a convex surface 22a which adjoins an annular flat 22b. Between the annular flat 22b and the mounting surface 16 is a reduced cross-section portion 14a of the nipple 14.

Located within the cavity 18 is a selected tire air pressure sensor 24, wherein air pressure at the orifice 20a is identical to the air pressure sensed by the tire air pressure sensor within the cavity 18.

The tire air pressure sensor 24 (see FIG. 3) is preferably of the active type, and includes: an electronic circuit 26 which includes a circuit board and a microprocessor, an air pressure sensing element 28 which preferably includes temperature and acceleration sensing elements, a wireless transmitter 30 including a radio frequency array and a printed transmitting antenna 30a, and a power source 32 in the form of battery for supplying power to the aforesaid electronic components. Preferably, fabrication is accomplished by the electronic components being assembled and then attached to a holder 34 as a sub-assembly 34a, then the sub-assembly is encapsulated by an overmold of the sensor body 10, wherein the holder defines the cavity 18 within the housing 12.

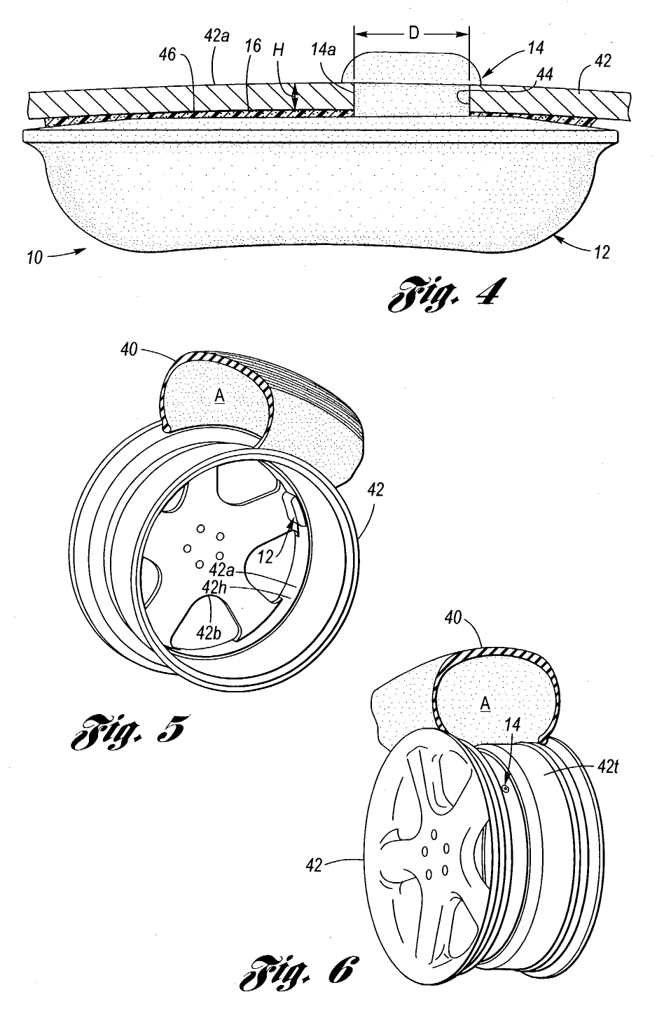

In order to interface the sensor body 10 operatively with pressurized air A inside a pneumatic tire 40 mounted to the tire-side 42t of the wheel rim 42a of a wheel 42, such that the pressurized air communicates with the cavity 18, a port hole 44 is provided in the wheel rim 42a of the wheel. The port hole 44 has a diameter approximately equal to (preferably for sealing, just smaller than) the diameter D of the reduced cross-section portion 14a of the nipple, and the height H of the reduced cross-section portion is approximately equal to the thickness of the wheel rim (see FIG. 4). Accordingly, in order to place the nipple 14 into the port hole 44, the annular flange must be resiliently deformed, wherein upon full insertion, the annular flange overlies the wheel rim in circumscribing relation to the port hole.

In operation, an adhesive 46 is applied onto more-or-less the entire mounting surface 16 of the housing 12 and then the nipple 14 is pushed through the port hole 44 such that the mounting surface is pressed against the hub-side 42h of the wheel rim 42a with the adhesive being squeezingly spread contactingly therebetween so as to also fill any voids. At this position, the annular flange overlies in circumscribing relation the wheel rim at the tire-side thereof. A primary seal of the air within the tire is provided by the overlying relation of the annular flange resulting in an axial sealing and the tight fit of the reduced cross-section portion resulting in a radial sealing. Additionally, when the adhesive dries, a secondary seal of the air within the tire is provided thereby. The adhesive may be any strong, durable, water-proof adhesive. At this position of the housing, as the wheel rotates the centripetal forces generated due to tire rotation will tend to press the housing to the wheel, thereby avoiding stress thereupon.

The air A within the tire is pressurized to the operational pressure for the tire after the adhesive has cured. The adhesive 46, external geometry of the housing 12 (in particular the convex curvature of the mounting surface 16) and the primary and secondary sealing of the port hole will provide a seal for the pressurized environment within the tire and hold the sensor housing in place on the wheel. The net force generated by the pressurized air inside the housing in a radial direction toward the wheel hub 42b is minimal, and is comparable to the force applied to the standard snap-in tire valve. The centripetal force generated by tire rotation will press the housing 12 toward the wheel rim 42a.

Certain of the advantages of the sensor body 10 being located at the hub-side of the wheel rim are: The location of the sensor body at the hub-side of the wheel rim will not interfere with wheel mounting to the axle, operation of the brakes, and tire mounting to the wheel; the low mass of the sensor body and its internal sensor will not adversely affect tire balancing operations; the sensor body eliminates the use of a tire valve or fastening belt for attaching a tire pressure sensor to a wheel, accordingly the cost and inventory of extra components is obviated; the sensor body can be attached to any kind of wheel rim (passenger cars, tractor trailers, etc) which diminishes the number of sensor body models in order to cover a wide range of vehicles; the sensor body locates the transmitting antenna outside of the wheel rim which thereby provides a high signal to noise ratio of the sensing elements; the material of the sensor body in conjunction with its location and mode of mounting on the wheel rim at the hub-side thereof diminishes significantly the effects of structural stresses, impacts and vibration on the sensor, resulting in increased life and reliability; and the location of the sensor body relative to the hub-side of the wheel rim lowers the cost of installation and diminishes the risk of damaging the sensor during tire change operations.

To those skilled in the art to which this invention appertains, the above described preferred embodiment may be subject to change or modification. For example, the sensor body could be held to the hub-side of the wheel rim by other than an adhesive. Such change or modification can be carried out without departing from the scope of the invention, which is intended to be limited only by the scope of the appended claims.

1. A pneumatic tire pressure sensor unit, comprising:
a sensor body comprising:
a housing having a mounting surface, said housing having a cavity formed therein; and
a nipple sealingly connected to said housing at said mounting surface, said nipple being oriented in upstanding perpendicular relation to said mounting surface, said nipple having a passage passing therethrough which communicates with said cavity; and
a tire pressure sensor located within said cavity;
wherein said cavity is sealed by said housing and said nipple such that said passage provides exclusive communication between said cavity and air pressure external to said sensor body.

2. The sensor unit of claim 1, wherein said nipple comprises:
an annular flange at a distal end of said nipple; and
a reduced cross-section portion located between said annular flange and said mounting surface.

3. The sensor unit of claim 2, wherein said annular flange comprises a convex surface adjoining an annular flat, wherein said reduced cross-section portion adjoins said annular flat.

4. The sensor unit of claim 1, wherein said mounting surface has a convex contour.

5. The sensor unit of claim 1, wherein said tire pressure sensor comprises:
an electronic circuit;
a wireless transmitter connected to said electronic circuit;
a tire air pressure sensing element connected to said circuit; and
a power source electrically powering said circuit, transmitter and sensing element.

6. The sensor unit of claim 5, wherein said nipple comprises:
an annular flange at a distal end of said nipple; and
a reduced cross-section portion located between said annular flange and said mounting surface.

7. The sensor unit of claim 6, wherein said mounting surface has a convex contour.

8. The sensor unit of claim 7, wherein said annular flange comprises a convex surface adjoining an annular flat, wherein said reduced cross-section portion adjoins said annular flat.

9. A wheel and pneumatic tire pressure sensor unit therefor, comprising:
a wheel having a wheel rim, said wheel rim having a hub-side and an opposite tire-side, a port hole being formed in said wheel rim;
a sensor body comprising:
a housing having a mounting surface, said housing having a cavity formed therein; and
a nipple sealingly connected to said housing at said mounting surface, said nipple being oriented in upstanding perpendicular relation to said mounting surface, said nipple having a passage passing therethrough which communicates with said cavity;
wherein said cavity is sealed by said housing and said nipple such that said passage provides exclusive communication between said cavity and air pressure at said tire-side of said wheel rim; and
a tire pressure sensor located within said cavity;
wherein said nipple projects through said port hole, and wherein said housing and said tire pressure sensor are located at said hub-side of said wheel rim.

10. The wheel and sensor unit of claim 9, wherein said nipple comprises:
an annular flange at a distal end of said nipple; and
a reduced cross-section portion located between said annular flange and said mounting surface;
wherein said annular flange overlies said tire-side of said wheel rim in circumscribing relation to said port hole.

11. The wheel and sensor unit of claim 10, wherein said annular flange comprises a convex surface adjoining an annular flat, wherein said reduced cross-section portion adjoins said annular flat, and wherein said annular flat sealingly overlies said tire-side of said wheel rim.

12. The wheel and sensor unit of claim 11, further comprising an adhesive adhering said mounting surface to said hub-side of said wheel rim in circumscribing relation to said port hole.

13. The wheel and sensor unit of claim 12, wherein said tire pressure sensor comprises:
an electronic circuit;
a wireless transmitter connected to said electronic circuit;
a tire air pressure sensing element connected to said circuit; and
a power source electrically powering said circuit, transmitter and sensing element.

14. A method for installing a pneumatic tire air pressure sensor unit to a pneumatic tire wheel, comprising the steps of:
assembling a tire pressure sensor as a sub-assembly;
molding over the sub-assembly a sensor body, wherein the sub-assembly is located in a cavity of a housing of the sensor body, and wherein a nipple projects from the housing;
fabricating a pneumatic tire wheel, wherein a port hole is provided in a wheel rim thereof; and
securing the housing to a hub-side of the wheel rim, wherein the nipple sealingly passes through the port hole to a tire-side of the wheel rim.

15. The method of claim 14, further comprising:
mounting a tire onto a tire-side of the wheel rim; and
after said step of securing, inflating the tire to a predetermined air pressure, wherein the air pressure is communicated to the cavity through the nipple.

16. The method of claim 15, wherein said step of securing comprises adhesively securing the housing to the hub-side of the wheel rim.
